(19) United States
(12) Patent Application Publication
(10) Pub. No.: US 2011/0107718 A1
(43) Pub. Date: May 12, 2011

(54) System for Finishing Openings in Log Structures

(76) Inventor: Jeff C. Middleton, Cedar City, UT (US)

(21) Appl. No.: 12/765,379

(22) Filed: Apr. 22, 2010

Related U.S. Application Data
(63) Continuation of application No. 10/873,828, filed on Jun. 21, 2004, now abandoned.
(60) Provisional application No. 60/479,680, filed on Jun. 19, 2003.

(51) Int. Cl. E04B 1/35; E06B 1/56

(52) U.S. Cl. 52/745.16

(57) ABSTRACT

A method for finishing a window opening in a log structure during erection of the log structure comprises: at least partially forming a wall of the log structure by placing at least one support log into a wall position; disposing a pre-assembled window opening frame upon the support log; nestably engaging a side receiving channel of one a pair of side frame pieces of the pre-assembled window opening frame with an end of at least one wall component log stacked vertically atop the support log and adjacent the side frame piece; and stacking a frame header log vertically atop an upper frame piece of the pre-assembled window opening frame.

### PRIORITY CLAIM

This application is a continuation of copending U.S. patent application Ser. No. 10/873,828, filed Dec. 23, 2004, which claimed priority from U.S. Provisional Application No. 60/479,680, filed Jun. 19, 2003, each of which is hereby incorporated herein by reference.

### BACKGROUND OF THE INVENTION

1. Field of the Invention

The present invention relates generally to systems for erecting log structures having finished openings therein.

2. Related Art

Un-planed logs have been used for many years in the construction of what have become popularly known as “log” homes, buildings or structures (hereinafter referred to as “log homes”). A typical un-planed log used in log structures generally begins as a piece of timber that has been stripped of its branches and bark, and has been hewn into a natural looking, unprocessed or un-planed log. The wide-spread availability of planed, finished lumber products has resulted in fewer structures being formed primarily of un-planed logs, however, log structures are still popular with many people. This popularity is due, in part, to the rustic, outdoors appearance provided by log structures and by the relative simplicity of constructing log structures.

In a typical log structure, un-planed logs are generally formed with a cross-sectional shape that allows multiple logs to be stacked one upon another to form a wall. For instance, logs are often formed in a generally round cross-sectional shape with a convex, projecting top, and a concave, recessed bottom. When stacked, the concave bottom of an upper log fits snugly over and within the convex top of a lower log. Generally, the logs are nailed or staked together as they are stacked into a wall to maintain the logs securely in place. Areas near ends of the logs can be notched to facilitate intersection of walls oriented transversely with respect to each other.

Assembling logs into a log structure can be done in a number of ways. In what is perhaps the most basic scenario, a quantity of logs can be acquired, shipped to a building site, cut to the proper length, shaped, notched, and assembled to form a wall of the structure. To simplify or streamline this process, some building supply companies have developed log structure “kits” which can include substantially all of the logs required for a particular structure, each of which is already cut to the proper length. In such an application, the pre-cut logs can be assembled according to a set of instructions which indicate where and how each log is to be installed or placed in the structure.

While log home kits have simplified the erection of log homes, one aspect of log home construction has remained considerably time consuming; that is, the finishing of openings in the log home. Openings, such as door and window openings, must generally by fitted with door or window jambs to accommodate the door or window structure to be installed therein. In conventional log home systems, door or window jambs, and their accompanying finishing trim, are applied to the log structure after the structure has been erected. In a typical scenario, a door or window opening in a wall is first generally “roughed in,” that is the opening is roughly formed in the structure, as the walls are built. Once the structure has been erected, workers return to the openings and “true” each log terminating beside the opening to form a continuous and planar vertical inside surface. After the opening has been planed, the door or window jamb is built piece-by-piece inside and around the opening. Once the jamb has been built, the door or window can be installed and the trim and/or jamb can be sanded, painted, stained, etc.

This finishing process has traditionally represented a large proportion of the time required to build a log structure, as openings generally must be either formed in the structure or, if already formed, finished to specification, before receiving a door or window. In addition to requiring many specialized tools, conventional methods of finishing doors and windows often require the presence of scaffolding or other structure to install windows or doors from the outside of the structure. This can result in an overly complex and dangerous operation for construction workers, and one in which the finished door or window jambs, or associated trim, are often not precisely or accurately mated with or applied to the log structure.

### SUMMARY OF THE INVENTION

It has been recognized that it would be advantageous to develop a system for building log structures by which finished window and/or door openings are formed within walls of the structure as the walls are erected. In addition, it has been recognized that it would be advantageous to develop a system for building log structures with pre-finished openings that can be installed from within the structure while the structure is erected, and which require little finishing work after the structure is erected.

The invention provides a kit for use in erecting a log structure having a finished window opening formed therein, including a plurality of logs, stackable relative to each other to form a wall of the log structure. The plurality of logs can include a lower support log, having a substantially horizontal support tenon formed in a top thereof, and an upper header log, having a substantially horizontal header tenon formed in a bottom thereof. At least one pre-assembled window opening frame can be disposable within the wall of the log structure during erection of the wall. The pre-assembled window opening frame can include: an upper frame piece, having a channel formed therein, the channel being configured to nestably engage the header tenon; a lower frame piece, having a channel formed therein, the channel of the lower frame piece being configured to nestably engage the support tenon; and a pair of side frame pieces coupled intermediate the upper and lower frame pieces, each side frame piece having a side receiving channel formed in an outward side thereof. The side receiving channels can be configured to nestably engage at least a portion of one of a plurality of wall component logs stacked adjacent to the side frame pieces and vertically atop the support log.

In accordance with another aspect of the invention, a kit for use in erecting a log structure having a finished door opening formed therein is provided, including a plurality of logs, stackable relative to each other to form a wall of the log structure. The plurality of logs can include a header log, having a substantially horizontal header tenon formed in a bottom thereof; and at least one pre-assembled door opening frame, disposable within the wall of the log structure during erection of the wall. The pre-assembled door opening frame can include an upper frame piece, having a channel formed therein, the channel being configured to nestably engage the header tenon; and a pair of side frame pieces coupled to and extending downwardly from the upper frame piece. Each side frame piece can have a side receiving channel formed in an outward side thereof, the side receiving channels being configured to nestably engage at least a portion of one of a plurality of wall component logs stacked adjacent to the side frame pieces and below the support log.

In accordance with another aspect of the present invention, a method for finishing a window opening in a log structure during erection of the log structure is provided, including the steps of at least partially forming a wall of the log structure by placing at least one support log into a wall position and disposing a pre-assembled window opening frame upon the support log. The method can include the further steps of: nestably engaging a side receiving channel of one of a pair of side frame pieces of the pre-assembled window opening frame with an end of at least one wall component log stacked vertically atop the support log and adjacent the side frame piece; and stacking a frame header log vertically atop an upper frame piece of the pre-assembled window opening frame.

In accordance with another aspect of the present invention, a method for finishing a door opening in a log structure during erection of the log structure is provided, including the step of placing a pre-assembled door opening frame upon a supporting surface. The method can include the further steps of: engaging a side receiving channel of one of a pair of side frame pieces of the pre-assembled door frame opening with an end of one of a plurality of wall component logs stacked vertically atop the supporting surface and adjacent the side frame piece; and stacking a frame header log vertically atop an upper frame piece of the pre-assembled door opening frame.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a log structure in accordance with an embodiment of the present invention;

FIG. 2A is a partial sectional view of the pre-assembled door opening frame of FIG. 1 used in connection with D-Logs, taken along planar section 2 of FIG. 1 in accordance with an embodiment of the present invention;

FIG. 2B is a partial sectional view of the pre-assembled door opening frame of FIG. 1 used in connection with Swedish Cope logs having end tenons formed therein, taken along planar section 2 of FIG. 1 in accordance with an embodiment of the present invention;

FIG. 2C is a partial sectional view of the pre-assembled door opening frame of FIG. 1 used in connection with Swedish Cope logs, taken along planar section 2 of FIG. 1 in accordance with an embodiment of the present invention;

FIG. 3A is a partial sectional view of the pre-finished window opening assembly of FIG. 1 used in connection with D-Logs, taken along planar section 3 of FIG. 1 in accordance with an embodiment of the present invention;

FIG. 3B is a partial sectional view of the pre-finished window opening assembly of FIG. 1 used in connection with Swedish Cope logs, taken along planar section 3 of FIG. 1 in accordance with an embodiment of the present invention;

FIG. 4A is a partial top sectional view of the pre-finished window assembly of FIG. 1 used in connection with D-Logs, with a pre-assembled window disposed therein in accordance with an embodiment of the present invention;

FIG. 4B is a partial top sectional view of the pre-finished window assembly of FIG. 1 used in connection with Swedish Cope logs having end tenons formed therein, with a pre-assembled window disposed therein in accordance with an embodiment of the present invention;

FIG. 4C is a partial top sectional view of the pre-finished window assembly of FIG. 1 used in connection with Swedish Cope logs, with a pre-assembled window disposed therein in accordance with an embodiment of the present invention in accordance with an embodiment of the present invention;

FIG. 5A is a partial side sectional view of a pre-finished door assembly used in connection with D-Logs in accordance with an embodiment of the present invention;

FIG. 5B is a partial side sectional view of a pre-finished door assembly used in connection with Swedish Cope logs in accordance with an embodiment of the present invention;

FIG. 6 is a partial perspective view of a side frame piece having a series of shaped indentations corresponding to a cross section of a log, in accordance with another aspect of the invention; and

FIG. 7 is a perspective view of a log structure in accordance with another aspect of the invention, showing insertion of a window assembly into a pre-assembled opening frame.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

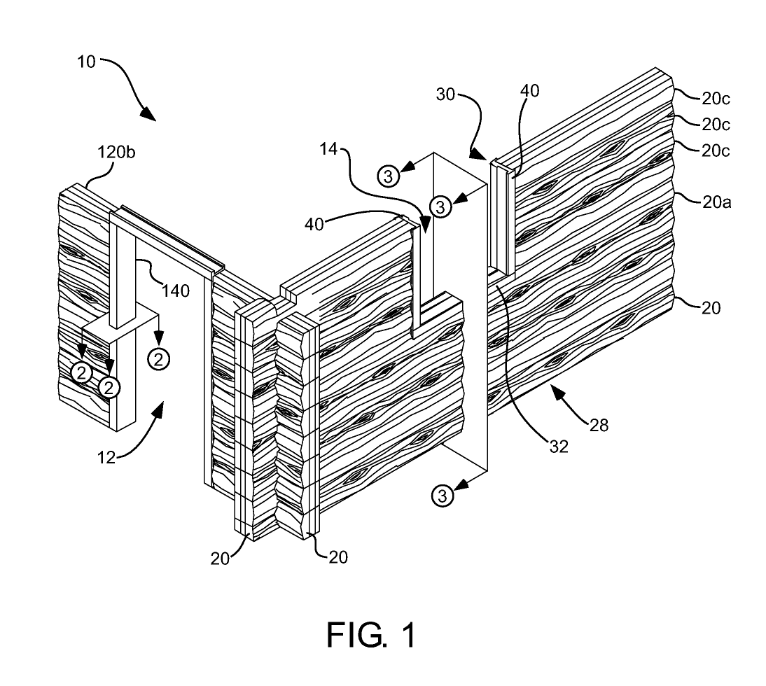

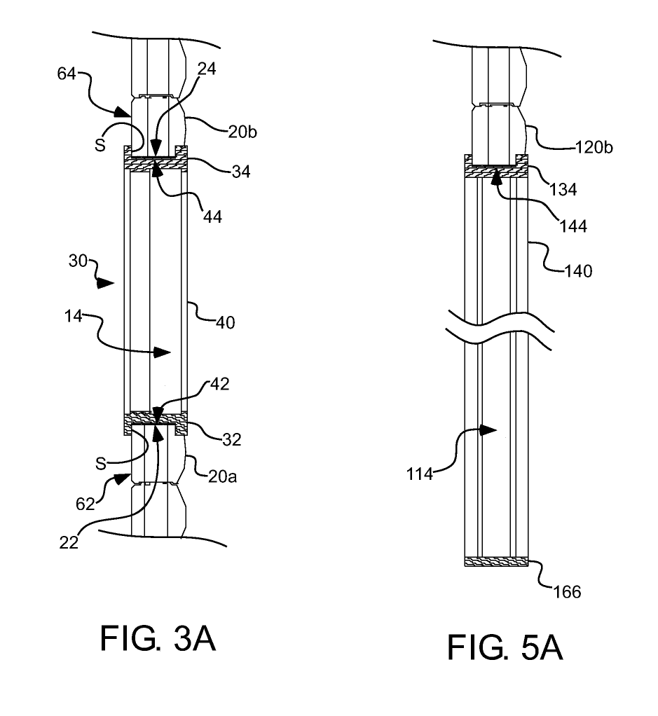

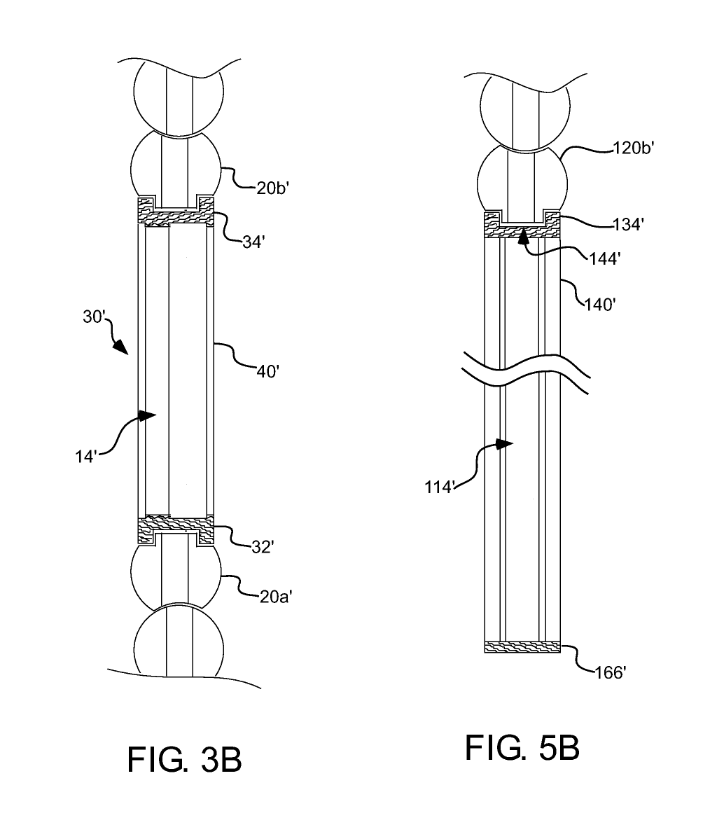

As illustrated in the accompanying figures, a system, indicated generally at 10, in accordance with the present invention is shown for a log structure. The system can be provided in the form of a log structure kit for erecting a log structure or home with a finished opening formed therein. In one aspect of the invention, discussed with reference to FIGS. 1 and 3A, the opening can include a finished window opening 14. The kit can include a plurality of logs 20 stackable one upon another to form walls of the log structure. The plurality of logs can include a support log 20a having an elongate support tenon 22 (FIG. 3A) formed in a top thereof. A header log 20b can have an elongate header tenon 24 formed in a bottom thereof. At least one pre-assembled opening frame 30 can be disposable within a wall 28 (FIG. 1) of the log structure during erection of the wall. The pre-assembled opening frame can include an upper frame piece 34 and a lower frame piece 32 (upper frame piece 34 shown removed in FIG. 1).

Each of the upper 34 and lower 32 frame pieces can have a channel 44, 42, respectively, formed therein. The channel 44 of the upper frame piece can be nestably engageable with the header tenon 24 and the channel 42 of the lower frame piece can be nestably engageable with the support tenon 22. As shown in more detail in top view in FIG. 4A, at least one of a pair of side frame pieces 40 can be coupled intermediate the upper 34 and lower 32 frame pieces (FIG. 1). Each side frame piece can have a side receiving channel 48 formed in an outward (with respect to the opening) side thereof. The receiving channels can be configured to mate with wall component logs 20c stacked outwardly adjacent to the side frame pieces and vertically atop the support log 20a (FIG. 1).

As will be appreciated from the figures, the upper and lower frame pieces and the side frame pieces cooperatively define a window or door opening frame. In one aspect of the invention, the window or door opening frame is provided as a finished, pre-assembled unit. In this manner, the system can be advantageously used by builders to erect log structures which are erected having completed opening frames installed therein. The system thus provides a variety of advantages not found in conventional systems. For example, in a conventional log home construction scenario, walls of the log home are generally formed by stacking logs one upon another until a desired height is achieved. When it is desired to leave an opening in the wall, such as for use with a window or a door, logs having reduced length are stacked adjacent to the location where the opening is to be formed, with ends of the logs terminating at sides of the openings. The ends of the logs terminating at the sides of the opening are often not cut to size, as the opening is generally “roughed in” for further finishing work after the walls have been constructed.

Thus, in a typical log home installation, once the walls have been constructed, the constructor returns to the roughed-in opening and, if necessary, cuts each of the wall logs to proper length and begins installing the finishing jamb or trim, which must often be installed piece-by-piece about the opening. In contrast, the present invention includes a pre-assembled opening frame 30 that can be disposed within a wall of the log home during construction of the log home. At the point where stacking of the logs exceeds the height of the opening in the wall, i.e., where logs are being stacked vertically higher than a top of the opening, the opening frame has already been finished within the opening. In the case where the opening frame is in a “natural” state, the opening frame is then ready for sanding, painting, staining, etc.

In one aspect of the invention, the pre-assembled opening frame can be provided in a “finished” state, that is the opening frame assembly can have been pre-sanded and painted or stained, and need not be finished once disposed in the opening. In this aspect of the invention, the invention not only provides a pre-assembled opening frame for a door or window opening, but can advantageously be used to reduce job site labor and materials conventionally required to finish window and door jambs. For example, the pre-assembled opening frame can be substantially complete with finishing trim, thereby eliminating the need to apply trim to the door or window frame after the door or window has been installed. In addition, the pre-assembled opening frame can be formed from a variety of materials, including wood, steel, vinyl, etc., or a combination thereof, as a particular application may dictate. For instance, the assembly can be formed of vinyl to eliminate the need to apply vinyl trim after installing a door or window. Vinyl or other trim can also be applied to the opening frame during pre-assembly of the frame to provide additional finishing aspects, i.e., a decorative appearance.

A further benefit of the present invention lies in the fact that the pre-assembled opening frame can be easily built into a wall as the wall is constructed. In this manner, door and window jambs can be substantially completely installed in the log structure by workers standing within the structure. Workers can thus avoid the need for a ladder or scaffolding to install the opening frame or jamb, which might otherwise be required in conventional systems wherein the jamb and finishing trim are applied from both the inside and the outside of the structure. In addition, exposed faces of the door or window frame openings of the present invention can be finished with a decorative profile formed therein, eliminating the need to apply decorative trim to the door or window openings at a later time. The decorative profile can be formed in interior or exterior exposed surfaces and can be varied, for example, so that the interior profile is different than the exterior profile to provide consumer with a variety of finished looks to choose from.

As used herein, the term “log” is to be understood to refer to logs having a configuration typically used in log homes or structures. Such logs are generally un-planed timbers that have been stripped of branches and bark, and have been hewn into a “natural” looking, unprocessed or un-planed log. Thus, the term “log” is meant to exclude typical dimensional lumber, such as “two-by-fours,” “two-by-eights,” etc. Similarly, the term “log” is meant to exclude planar or sheet lumber such as plywood, particle board, etc. As discussed in more detail below, the cross section of the log can be formed in a variety of cross sectional shapes, including a shape known to those skilled in the art as “Swedish Cope.” Additionally, the cross section or shape of the log can be a “D” shape, as used in logs commonly known as “D-Logs.”

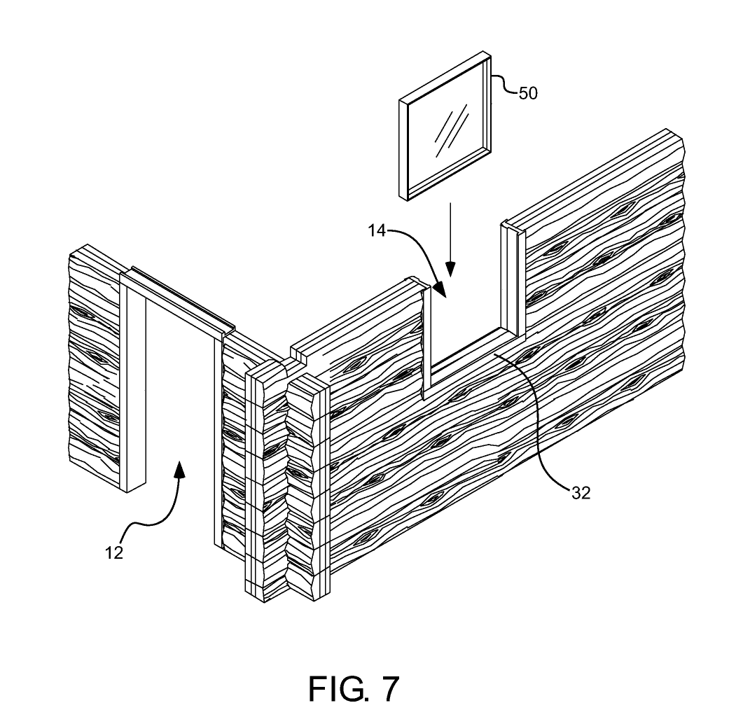

As illustrated in top view in FIGS. 4A through 4C, in one aspect of the invention the upper frame piece 34 (not shown in FIGS. 4A through 4C, as removed) can be removably coupled to the side frame piece or pieces 40. The upper frame piece can be configured to be removed after disposal of the window opening frame on the support log (20a in FIG. 1). In this manner, a window assembly 50 can be installed in the window opening frame 30 after or during installation of the window opening frame. The pre-assembled window opening frame can include an inner receiving channel 52 formed within and extending along each of the upper 34, lower 32 and side frame pieces 40. The receiving channel allows ease of installation of the window assembly within the window opening frame, as shown for example in FIG. 7.

As illustrated in FIGS. 4A through 4C, the logs of the present invention can be of a variety of cross section shapes. In the embodiment shown in top view in FIG. 4A, the wall component logs 20c include a substantially “D-shaped” cross section, as are known in the art (shown in side view in FIG. 3A). In this aspect, the D-Log can include an end tenon 60 that has a front edge 21 that mates with an edge 49 of side receiving channel 48. In the embodiment shown in top view in FIG. 4B, the wall component log 20c′ can include a Swedish Cope cross section (shown in side view in FIG. 3B) and can include an end tenon 60′ which can be configured to nestably engage within the side receiving channel 48. In this aspect, the side receiving channel can include an inner width W₁ and the end tenon can include an outer width W₂ which can be substantially the same as or less than the inner width of the receiving channel. In this manner, the end tenon can fit snugly within the side receiving channel to secure the log within the channel.

As the discussion herein relates to widths of channel or tenons, or diameters of logs, the term “substantially the same as” is to be understood to refer to a state wherein two mating components have dimension that are the same, or are so nearly the same as to still allow snug mating of one of the components within the other. Thus, as some components of the present system are primarily formed of wood, a component with a slightly larger size may be compressibly mated within a component having a slightly smaller opening in order to form a nestable relationship between the two components. It is to be understood that the immediately preceding scenario is contemplated to fall within the definition of two components having substantially the same size.

Turning now to FIG. 4C, in one aspect of the invention, the plurality of wall component logs 20c″ can include an outer diameter D and the side receiving channels 48″ of the side frame pieces 40″ can have a substantially constant inner width W₃. The substantially constant inner width of the receiving channel can be substantially the same as or greater than the outer diameter D of the plurality of wall component logs to facilitate nesting of ends of the wall component logs within the side frame pieces.

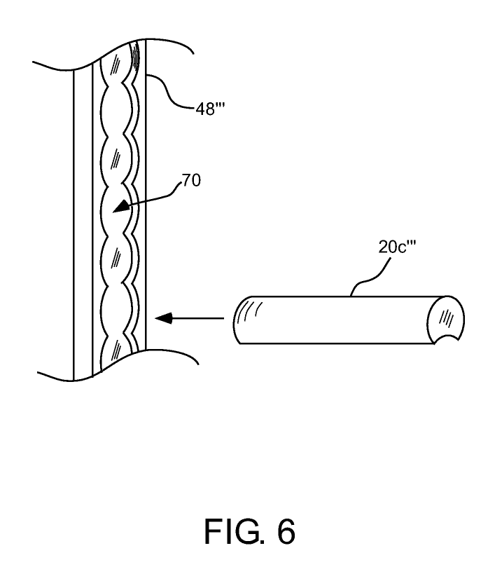

As shown in perspective view in FIG. 6, in one aspect of the invention, the side receiving channels 48″ of the side frame pieces can include a series of shaped indentations 70. Each of the indentations can be shaped to correspond to a cross section of each of the plurality of wall component logs 20c″ to facilitate nesting of ends of the wall component logs within the side receiving channels. In the aspect shown, the shaped indentations correspond to a Swedish Cope cross section of log 20c′″. In other aspects of the invention (not shown), the shaped indentations can correspond to a D-shaped cross section of a D-Log, or a variety of other cross sections, as are known to those skilled in the art.

Returning now to FIG. 3A, in one aspect of the invention, the header log 20a and support log 20b can include D-shaped logs, or D-Logs. In this embodiment, the header tenon 24 and support tenon 22 formed in the header and support logs, respectively, can each include a side surface S that is co-planar with a rear surface 64 of the header log and a rear surface 62 of the support log. Thus, the tenons formed in the header and support logs include a cross section that is not reduced along the rear surface of the logs. In this manner, only one side of the logs, and possibly a bottom of the logs, need be reduced to form the tenons.

In addition, the tenons 22, 24 formed in the support log 20a and the header log 20b can include a cross section that is reduced in size from a cross section of the support log and header log, respectively. Thus, the header and support log can include a tenon that is formed integrally from the logs to reduce the need for attaching additional structure to the logs to allow nestable engagement with the pre-assembled window opening frame. In one aspect of the invention, shown collectively in FIGS. 3A and 4A, the channels of the upper and lower frame pieces and each of the side receiving channels can collectively form a substantially constant channel circumscribing the pre-assembled window opening frame. In this manner, the opening frame can securely engage each of the bottom, top and sides of the window opening formed in the wall of the structure.

In addition to the embodiment illustrated and discussed in relation to FIG. 3A, FIG. 3B illustrates a similar embodiment for use with Swedish Cope logs. The system includes header log 20b′, support log 20a′ and side frame piece 40′ which collectively define window opening frame 30′. This aspect shares many of the features and advantages of previous aspects with the benefit of incorporating Swedish Cope logs instead of D-Logs.

The structure described above can be utilized in a variety of applications wherein a window opening frame is to be built into a structure. In addition, as shown in FIGS. 1, 2A through 2C, and 5A and 5B, the present invention also provides a kit for use in erecting a log structure having a finished door opening 114 formed therein. This kit can include many of the features and advantages of previous embodiments, and can have a plurality of logs 120c, stackable relative to each other to form a wall of the log structure. Side frame 140 can be included in this embodiment, similar to side frame pieces 40 in FIGS. 4A-4B. As shown in FIG. 5A, upper frame piece 134 can receive and support header log 120b in channel 144.

The primary difference between the embodiments for use with window opening frames and door opening frames is that the door opening frames may not include a support log. Instead, the door opening frame may include a lower support rail 166 which can be disposed on a floor or threshold surface (not shown).

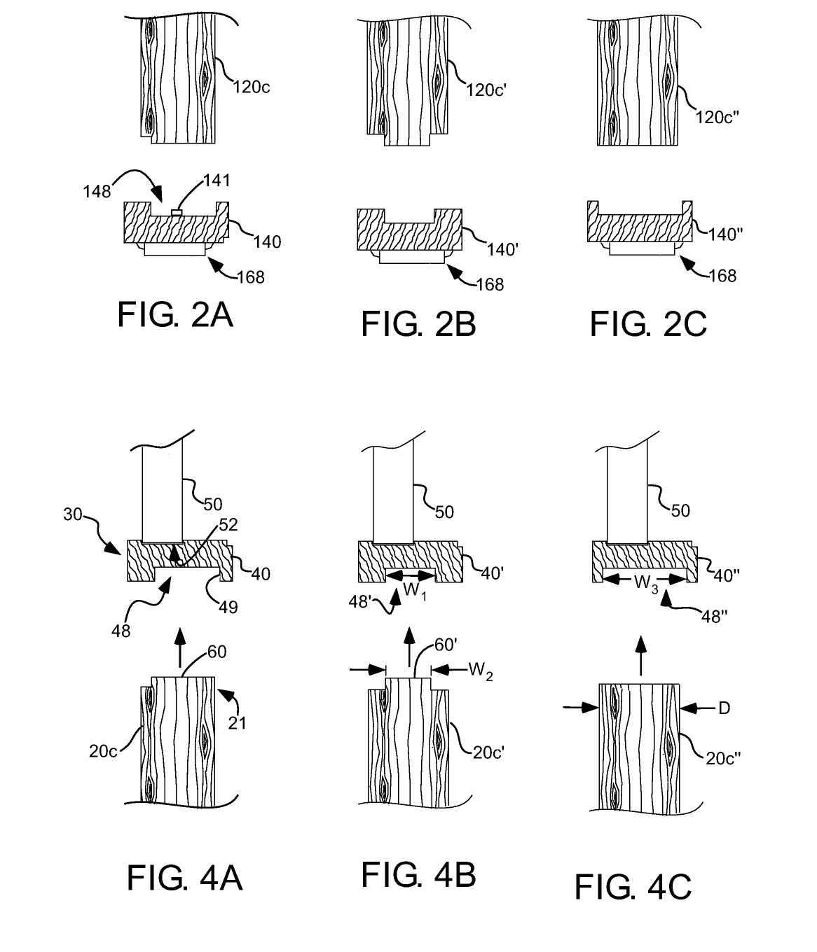

The kit of this embodiment can include a door assembly disposable within the pre-finished door frame opening, shown partially by example with door jamb trim 168 in FIGS. 2A through 2C. The door assembly can include a door with accompanying mounting hardware such as hinges, door stops, etc., formed or attached within the door frame opening. In addition, the door assembly can also include a pre-hung door including hinges, knob hardware, etc., built within the door assembly to allow the door assembly to be mounted as an integral piece within the door frame opening.

As shown by example in FIG. 2A, a gasket 141 can be disposed between the side frame piece 140 and the logs 120c. The gasket can aid in maintaining a weather-tight seal between ends of the logs and the side frame pieces. Similarly, the gasket can substantially circumscribe the window or door frame assembly to thereby provide a seal between each component of the kit, including side frame pieces, upper frame pieces and lower frame pieces. The gasket can be formed of a variety of materials, and in one aspect is formed of a foam material that can maintain an operative seal while allowing some expansion or contraction of the door or window frame components and adjacent logs.

The present invention also provides a method for utilizing the novel structure disclosed above. The method can include the steps of: at least partially forming a wall of the log structure by placing at least one support log into a wall position; disposing a pre-assembled window opening frame upon the support log, the pre-assembled window opening frame including: i) a lower frame piece; ii) a pair of side frame pieces coupled to and extending upwardly from the lower frame piece, each side frame piece having a side receiving channel formed in an outward side thereof; and iii) an upper frame piece. The method can include the further steps of: nestably engaging the side receiving channel of one of the side frame pieces with an end of at least one wall component log stacked vertically atop the support log and adjacent the side frame piece; and stacking a frame header log vertically atop the upper frame piece of the pre-assembled window opening frame.

The method can include the further step of disposing a window assembly within an inner receiving channel formed in the upper, lower and side frame pieces.

The method can in clued the further steps of: removing the upper frame piece after disposal of the window opening frame on the support log; installing a window assembly in the window opening frame; and coupling the upper frame piece to the side frame pieces.

In accordance with another aspect of the invention, a method for finishing a door opening in a log structure during erection of the log structure is provided, including the steps of: placing a pre-assembled door opening frame upon a supporting surface, the pre-assembled door opening frame including: i) a pair of side frame pieces coupled to and extending upwardly from the lower frame piece, each side frame piece having a receiving channel formed in an outward side thereof; and ii) an upper frame piece. The method can include the further steps of: engaging the side receiving channel of one of the side frame pieces with an end of one of a plurality of wall component logs stacked vertically atop the supporting surface and adjacent the side frame piece; and stacking a frame header log vertically atop the upper frame piece of the pre-assembled door opening frame. The pre-assembled door frame can include a pre-hung door disposed therein.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. A method for finishing a window opening in a log structure during erection of the log structure, comprising the steps of:
at least partially forming a wall of the log structure by placing at least one support log into a wall position;
disposing a pre-assembled window opening frame upon the support log;
nestably engaging a side receiving channel of one a pair of side frame pieces of the pre-assembled window opening frame with an end of at least one wall component log stacked vertically atop the support log and adjacent the side frame piece; and
stacking a frame header log vertically atop an upper frame piece of the pre-assembled window opening frame.

2. The method of claim 1, wherein the pre-assembled window opening frame includes an inner receiving channel formed within the lower frame piece and side frame pieces, and comprising the further step of disposing a window assembly within the inner receiving channel.

3. The method of claim 1, wherein the upper frame piece is removably coupled to the side frame pieces, and comprising the further steps of:
i) removing the upper frame piece after disposal of the window opening frame on the support log;
ii) installing a window assembly in the window opening frame; and
iii) coupling the upper frame piece to the side frame pieces.

4. The method of claim 1, wherein each of the plurality of wall component logs includes an outer diameter, and wherein the side receiving channels of the side frame pieces have an inner width substantially the same as or larger than the outer diameter of the plurality of wall component logs.

5. The method of claim 1, wherein the side receiving channels of the side frame pieces include a series of shaped indentations, each indentation being shaped to correspond to a cross-section of each of the plurality of wall component logs.

6. The method of claim 1, wherein the side receiving channels of the side frame pieces have an inner width, and wherein an end of each of the wall component logs includes an end tenon having an outer width substantially the same as or less than the inner width of the side receiving channels, the end tenons of the wall component logs being nestable within the side receiving channels.

7. The method of claim 1, wherein the header and support logs comprise D-shaped logs, and wherein the tenons formed in the header and support logs each include a side surface that is co-planar with a rear surface of the header and support logs, respectively.

8. The method of claim 1, comprising the further step of reducing in size a cross section of each of the header and support logs to form tenons therein, the tenons being configured to nestably engage channels formed in the pre-assembled window frame opening.

9. A method for finishing a door opening in a log structure during erection of the log structure, comprising the steps of:
placing a pre-assembled door opening frame upon a supporting surface;
engaging a side receiving channel of one of a pair of side frame pieces of the pre-assembled door opening frame with an end of one of a plurality of wall component logs stacked vertically atop the supporting surface and adjacent the side frame piece; and
stacking a frame header log vertically atop an upper frame piece of the pre-assembled door opening frame.

10. The method of claim 9, wherein the pre-assembled door frame includes a pre-hung door disposed therein.

11. The method of claim 9, wherein each of the plurality of wall component logs includes an outer diameter, and wherein the receiving channels of the side frame pieces have an inner width substantially the same as or larger than the outer diameter of the plurality of wall component logs.

12. The method of claim 9, wherein the receiving channels of the side frame pieces include a series of indentations, each indentation being shaped to correspond to a cross section of each of the plurality of wall component logs.

13. The method of claim 9, wherein the receiving channels of the side frame pieces have an inner width, and wherein an end of each of the wall component logs includes an end tenon having an outer width substantially the same as or smaller than the inner width of the receiving channels, the end tenons of the wall component logs being configured to each engage the side receiving channels of the side frame pieces.

14. The method of claim 9, wherein the plurality of logs comprise D-shaped logs, and wherein the tenon formed in the frame header log includes a side surface that is co-planar with a rear surface of the D-shaped frame header log.

15. The method of claim 9, wherein the tenons formed in the frame header log include a cross section reduced in size from a cross section of the frame header log.
